(19) United States
(12) Patent Application Publication
(10) Pub. No.: US 2019/0196422 A1
(43) Pub. Date: Jun. 27, 2019

(54) TUNING SYSTEM, SIMULATION UNIT AND TUNING AND SIMULATION METHOD THEREOF

(71) Applicant: INDUSTRIAL TECHNOLOGY RESEARCH INSTITUTE, Hsinchu (TW)

(72) Inventors: Chen-Yu Kai, Hsinchu (TW); Chen-Hui Kuo, Hsinchu (TW); Ta-Jen Peng, Hsinchu (TW)

(21) Appl. No.: 15/851,825

(22) Filed: Dec. 22, 2017

(51) Int. Cl. G05B 13/04; G06F 17/50

(52) U.S. Cl. CPC G05B 13/047; G05B 13/042; G06F 17/5009; G06F 17/5086

(57) ABSTRACT

A tuning method is to provide a tuning system equipped with a virtual machine which is modeled after a target machine, set the processing conditions of the target machine into the tuning system, enter a simulation command containing simulation parameters into the virtual machine, subject the virtual machine to simulate the response of the target machine according to the simulation parameters to calculate required control parameters, and use the control parameters as the base parameters for adjusting the target machine.

### TECHNICAL FIELD

The present disclosure relates to methods for automatically adjusting parameters, and, more particularly, to a tuning method that facilitates users in adjusting parameters and a tuning system using the same.

### BACKGROUND

With the rapid development of automatic machine tools, processing operations carried out by input of related parameters has become mainstream these days. These machine tools are usually subjected to tuning before they leave the factory. By adjusting the relevant parameters, the machine tools will be able to meet certain performance indices and the requirements specified by the clients.

However, after leaving the factory, the original machine performance is often influenced by factors such as site installation, site construction, and environmental issues. In addition, mechanical components may take a lot of wear and tear or even have structural deformations due to vibration, friction, dust, or the like after a long period of operation, which may cause changes in the characteristics of the machine, resulting in performance degradation. It would be difficult in practice to repair mechanical components or structures by dismantling the machine apart in order to improve the performance of the machine.

Furthermore, in order to tune the parameters of a controller of the machine, one needs to be familiar with the functions of the machine's functions, understand its performance, and have certain level of professional knowledge about the machine's design and manufacturing processes. In other words, the user must be an experienced operator or it would be difficult to tune the machine in real time on a production line of a factory.

Therefore, how to enable an ordinary operator to tune a variety of machine tools on a production line of a factory in real time is a technical problem which urgently requires a solution.

### SUMMARY

In view of the aforementioned shortcomings of the prior art, the present disclosure provides a tuning method, which may include: providing a tuning system equipped with a virtual machine, wherein the virtual machine is modeled after a target machine; setting a processing condition of the target machine in the tuning system; inputting a simulation command containing a simulation parameter into the virtual machine; and subjecting the virtual machine to simulate a response of the target machine according to the simulation parameter to calculate a required control parameter and use the control parameter as a base parameter for adjusting the target machine.

In an embodiment, the tuning system may be further provided with an identification module, and before setting the processing condition, the tuning method may further comprise: inputting another simulation command containing another simulation parameter into the virtual machine for the target machine to generate response information; transmitting the response information to the identification module; and subjecting the identification module to compare the another simulation command and the response information, and using the another simulation parameter and the response information as a system parameter if an error value of the another simulation parameter is within an acceptable range. Further, the tuning system may be further provided with a simulation unit for transmitting the another simulation command to the target machine and the identification module. In an embodiment, the target machine may include a controller, and the simulation unit may be configured for simulating the controller.

In an embodiment, the tuning system may be further provided with a reference model established by using the virtual machine, and the reference model may include comparison parameters. In another embodiment, the tuning method may further comprise selecting the reference model based on the processing condition of the target machine, and comparing with the control parameter to calculate another control parameter.

The present disclosure provides a tuning system, which may comprise: a server equipped with a virtual machine, wherein the virtual machine is modeled after a target machine; an identification module for identifying the target machine to establish the virtual machine; and a simulation unit for simulating a controller of the target machine for the identification to be performed by the identification module.

In an embodiment, the simulation unit is configured for transmitting a simulation command to the target machine and the identification module for the identification to be performed by the identification module.

The present disclosure provides a simulation method for simulating a controller by a simulation unit. The controller is configured for controlling motions of a target machine. The simulation method may include: setting a parameter for a simulation trajectory; calculating a simulation command based on the parameter; and inputting the simulation command into the target machine for response comparison to determine whether the simulation command corresponds to a target command of the controller for controlling the target machine.

The present disclosure provides a simulation unit, which may comprise: a data collection portion for setting a parameter for a simulation trajectory; a calculation portion for calculating a simulation command based on the parameter; and an analysis portion for inputting the simulation command into the target machine for response comparison to determine whether the simulation command corresponds to a target command of the controller for controlling the target machine.

In an embodiment, the simulation unit is another controller. In an embodiment, the data collection portion sets the parameter for the simulation trajectory by collecting motion parameter information of the controller.

In an embodiment, the analysis portion determines whether the simulation command corresponds to the target command based on the correlation between the simulation trajectory and motions of the target machine.

From the above, the tuning method and the tuning system using the same according to the present disclosure construct the virtual machine to acquire relevant parameters of the target machine in order to simulate the response of the target machine and calculate required control parameters in real time. These control parameters are used by users as initial values for adjusting the parameters of the target machine. Thus, compared to the prior art, the tuning method according to the present disclosure allows an operator to quickly input control parameters into the target machine regardless of the experience of the operator, thereby saving significant amount of time the user has to spend in adjusting the parameters of the target machine.

### BRIEF DESCRIPTION OF THE DRAWINGS

FIG. 1A is a schematic diagram depicting an arrangement of a tuning system in accordance with the present disclosure;

FIG. 1B is a block diagram depicting functional elements of a tuning method in accordance with the present disclosure;

FIG. 2A is a flowchart illustrating a simulation process of a simulation unit in accordance with the present disclosure;

FIGS. 2B and 2C are graphs illustrating the generation of simulation parameters by a data collection portion of the simulation unit in accordance with the present disclosure;

FIGS. 2D-1 to 2D-4 are graphs illustrating the generation of different simulation trajectories by the simulation unit in accordance with the present disclosure;

FIG. 3A is a schematic diagram illustrating construction of a virtual machine in conjunction with an identification module in accordance with the present disclosure;

FIGS. 3B-1 and 3B-2 are diagrams depicting interfaces of the identification module in accordance with the present disclosure;

FIG. 3C is a flowchart illustrating the tuning system performing system identification in accordance with the present disclosure;

FIG. 4A is a flowchart illustrating a tuning method in accordance with the present disclosure;

FIG. 4B is a schematic diagram depicting processing requirements for the tuning method in accordance with the present disclosure;

FIGS. 4C to 4D are diagrams depicting interfaces of the virtual machine of the tuning system during automatic parameter adjustment in accordance with the present disclosure;

FIG. 4E is a diagram depicting another interface of the virtual machine of the tuning system in accordance with the present disclosure;

FIGS. 4F-1 to 4F-3 are graphs illustrating verification of processing statuses after tuning for different processing requirements in FIG. 4B;

FIG. 5 is a flowchart illustrating the tuning system establishing a reference model in accordance with the present disclosure; and

FIG. 6 is a flowchart illustrating the tuning method using the reference model of FIG. 5 in accordance with the present disclosure.

### DETAILED DESCRIPTION OF THE EMBODIMENTS

The technical content of present disclosure is described by the following specific embodiments. One with ordinary skill in the art can readily understand the advantages and effects of the present disclosure upon reading the disclosure of this specification. The present disclosure may also be practiced or applied with other different implementations. Based on different contexts and applications, the various details in this specification can be modified and changed without departing from the spirit of the present disclosure.

It should be noted that the structures, ratios, sizes shown in the drawings appended to this specification are to be construed in conjunction with the disclosure of this specification in order to facilitate understanding of those skilled in the art. They are not meant, in any ways, to limit the implementations of the present disclosure, and therefore have no substantial technical meaning. Without affecting the effects created and objectives achieved by the present disclosure, any modifications, changes or adjustments to the structures, ratio relationships or sizes, are to be construed as fall within the range covered by the technical contents disclosed herein. Meanwhile, terms, such as “one”, “a”, “an”, and the like, are for illustrative purposes only, and are not meant to limit the range implementable by the present disclosure. Any changes or adjustments made to their relative relationships, without modifying the substantial technical contents, are also to be construed as within the range implementable by the present disclosure.

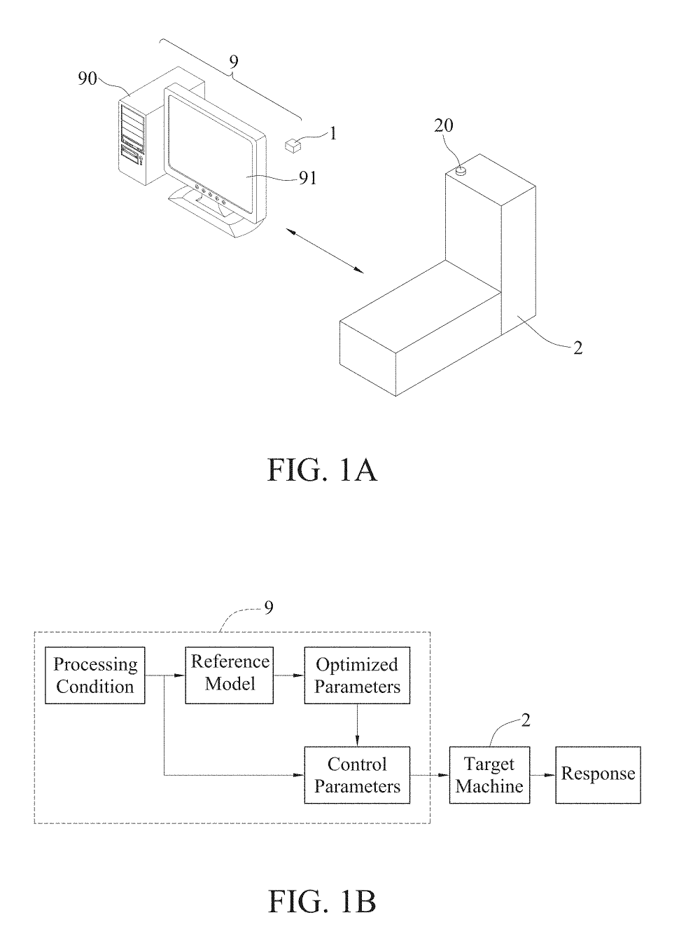

Referring to FIGS. 1A and 1B, schematic diagrams illustrating a tuning system and a tuning method for the same in accordance with the present disclosure are provided.

As shown in FIG. 1A, a tuning system 9 is used for adjusting the parameters of a target machine 2. The tuning system 9 may be a computer or other equipment with a human-machine interface, and include a server 90, a screen 91 and a simulation unit 1.

In an embodiment, the target machine 2 is an automation control machine tool (e.g., a CNC lathe) equipped with a controller 20 for controlling the operations (e.g., processing) of the target machine 2.

The server 90 is used for simulating the operations of the target machine 2 and displaying the simulation results in the form of a virtual machine on the screen 91.

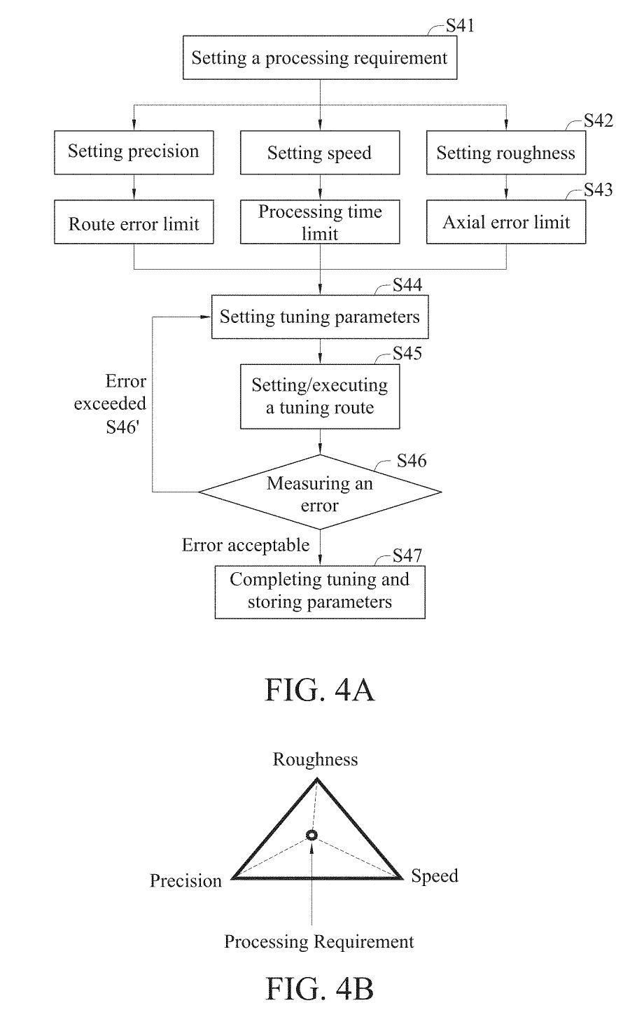

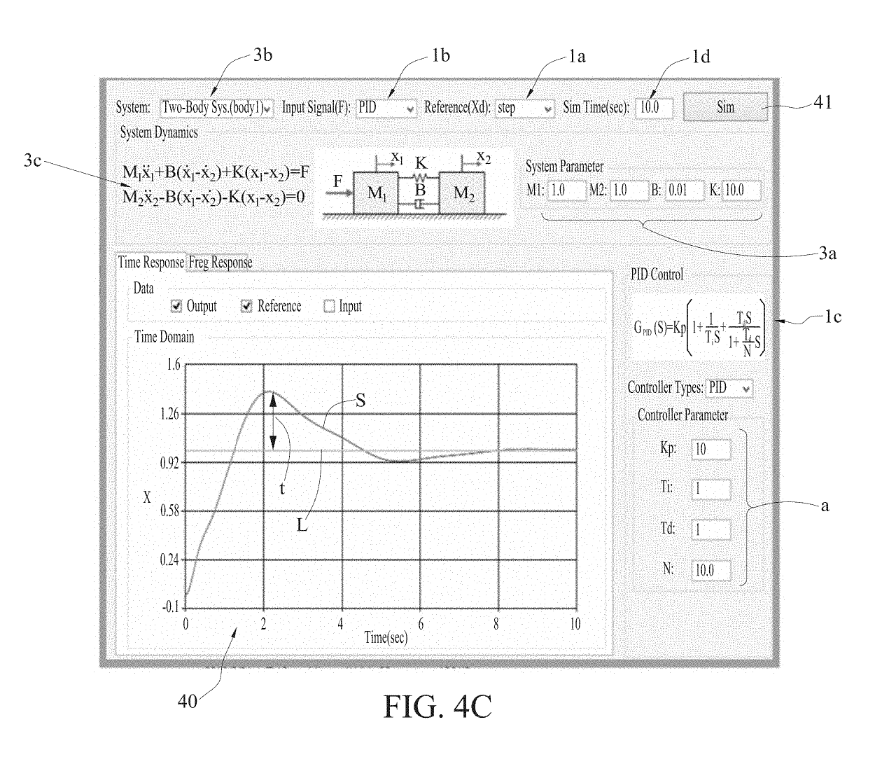

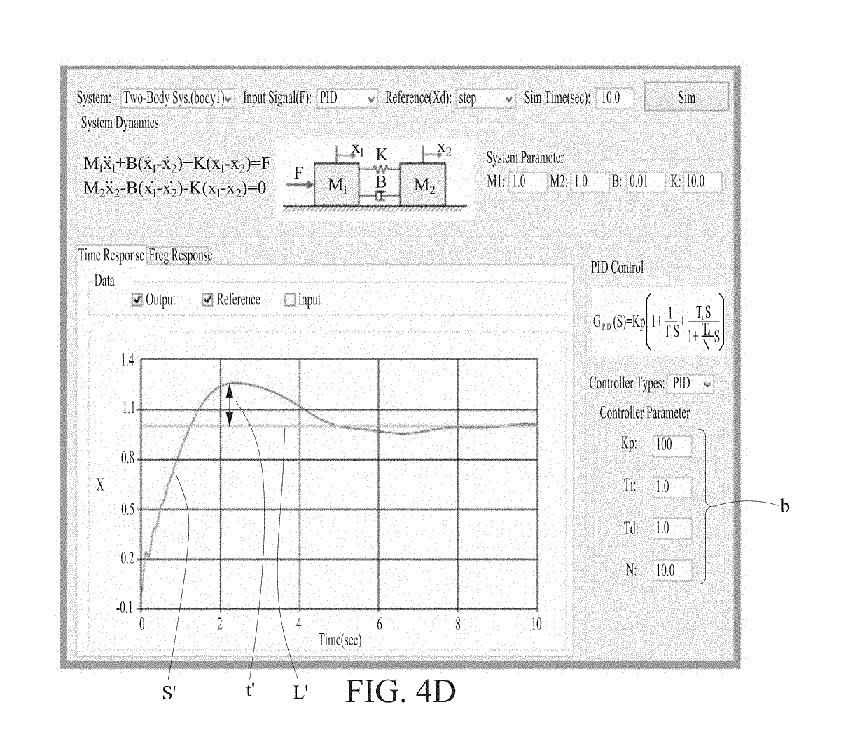

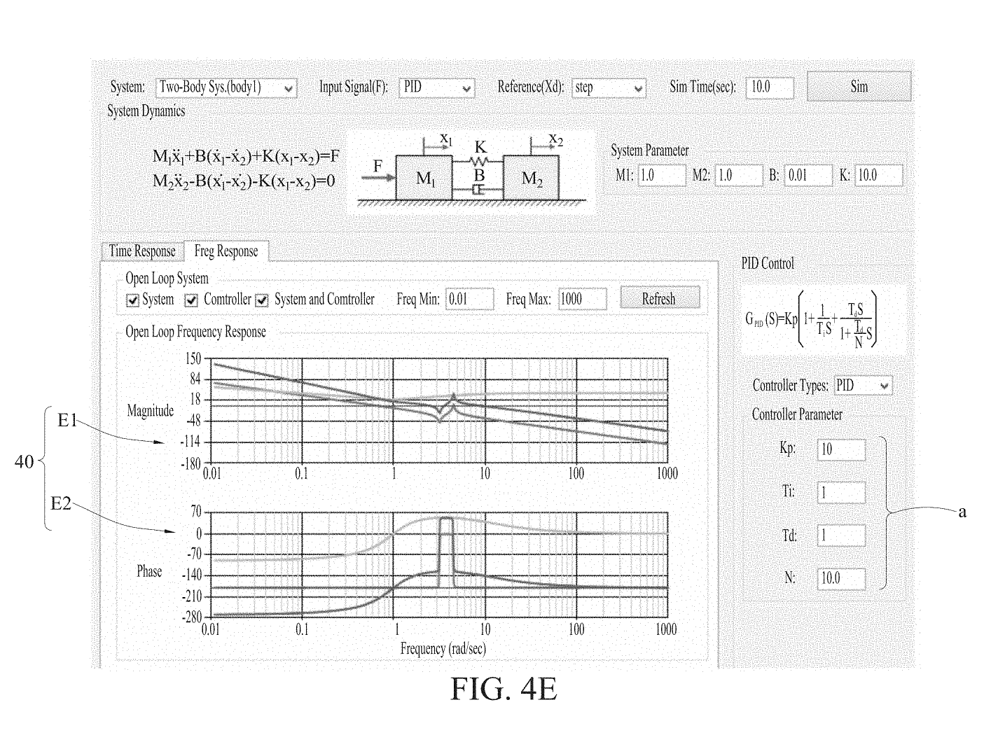

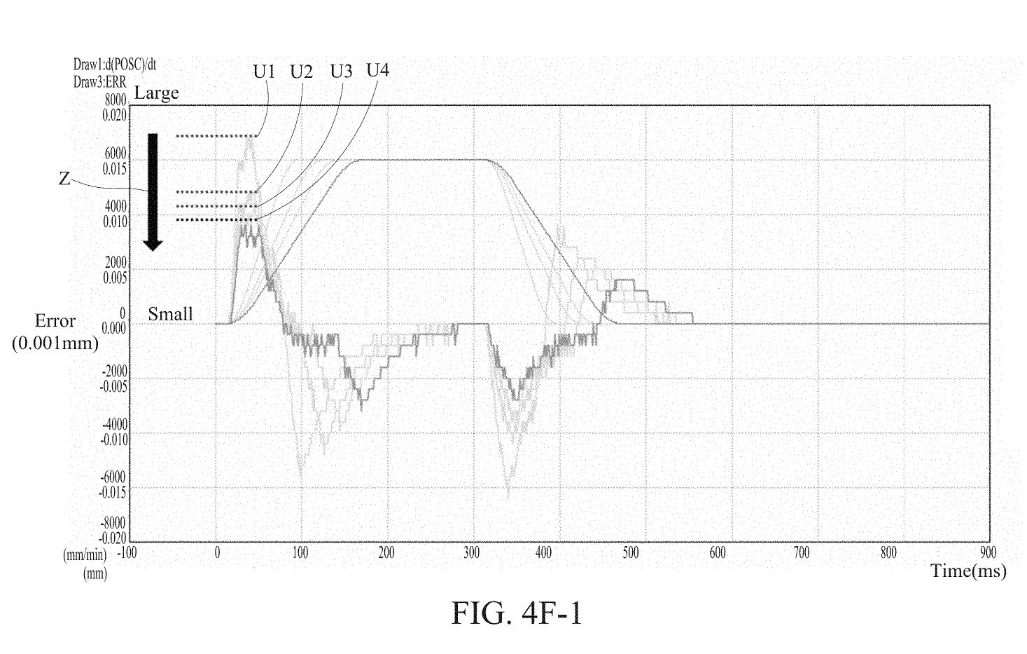

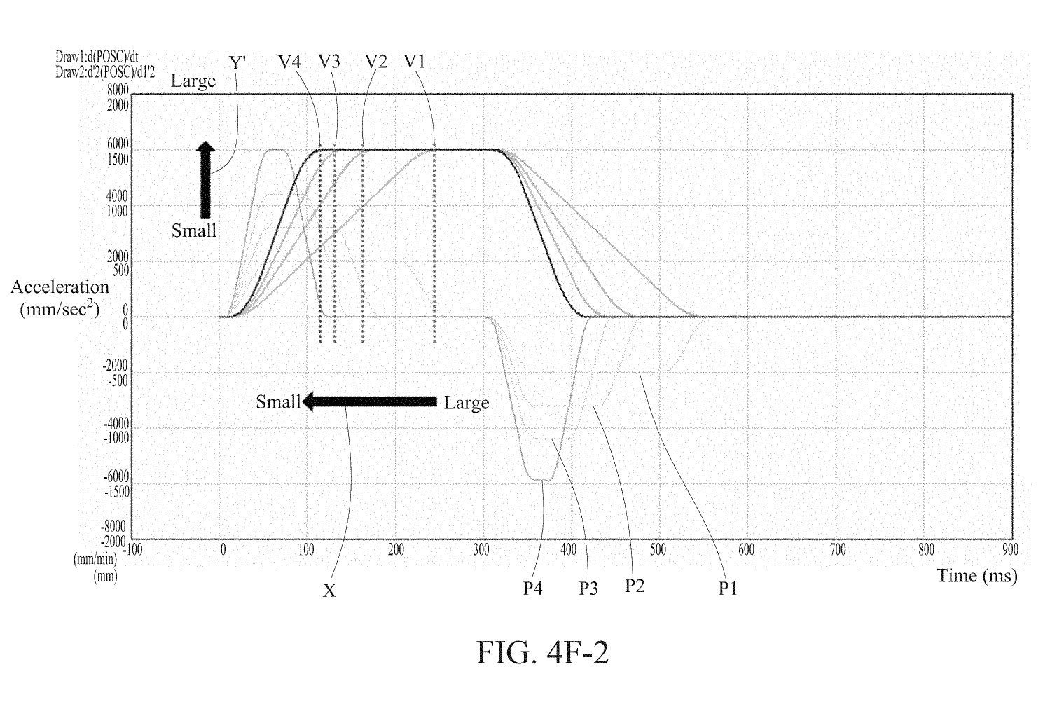

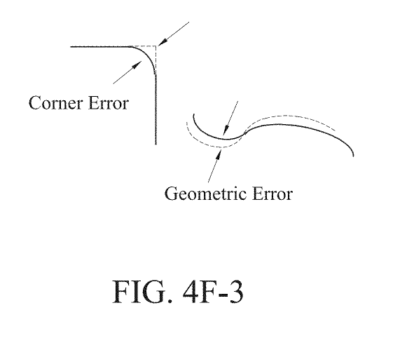

In an embodiment, the virtual machine is used for simulating motion statuses of the target machine 2 before and after adjusting the parameters of the controller 20. In an embodiment, the virtual machine includes a plurality of interfaces for displaying parameters (e.g., interfaces shown in FIGS. 4D to 4F). It can be appreciated that the virtual machine may optionally display the physical appearance of the target machine 2.

Therefore, the simulation accuracy of the virtual machine is critical. The establishing of the virtual machine is now described in details.

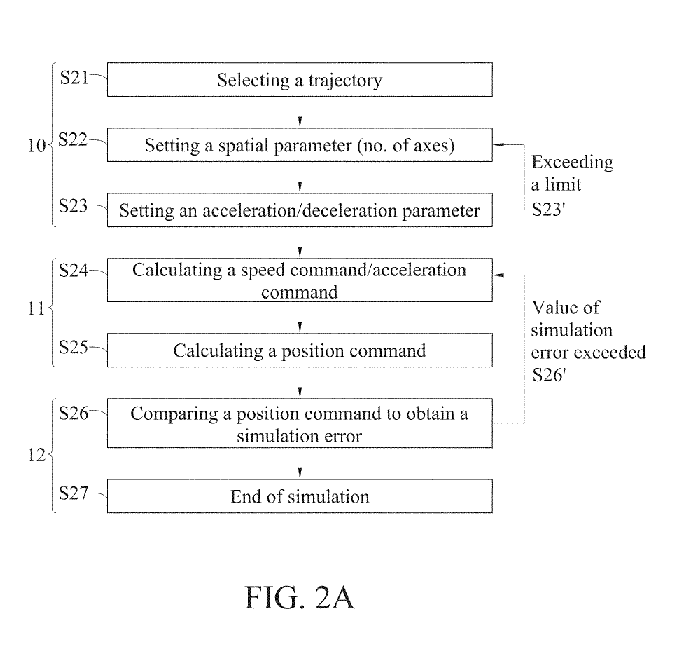

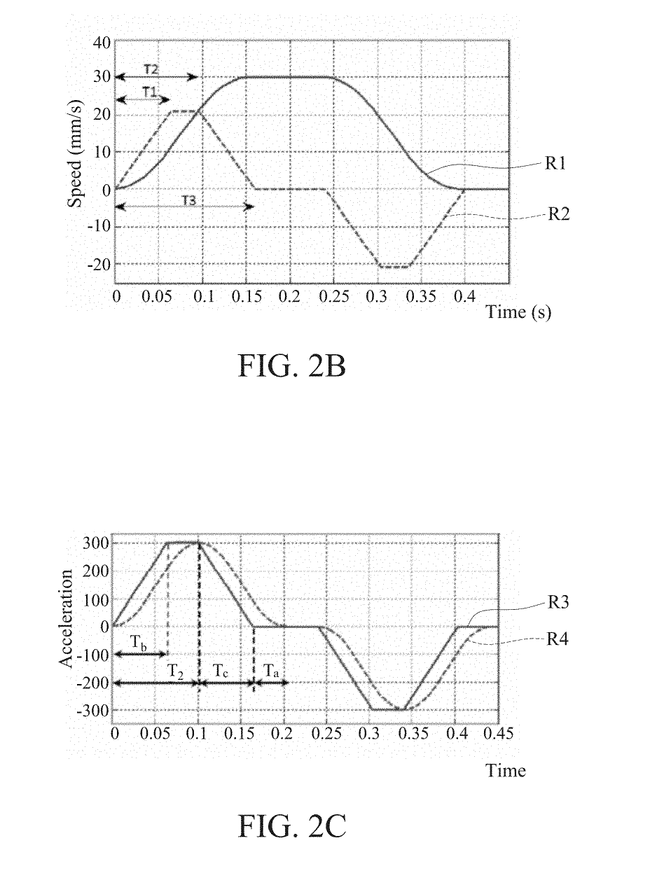

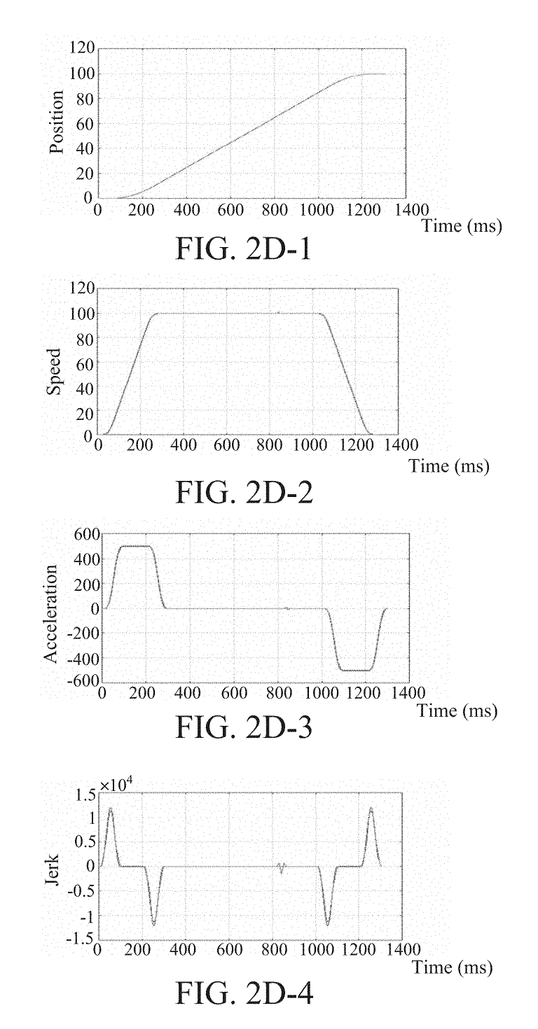

Referring to FIGS. 2A to 2D-4, schematic diagrams depicting the simulation unit 1 and its simulation processes are shown.

Since the application of the virtual machine involves various parameters of the controller 20, a device capable of simulating the controller 20 is needed, such as the provision of the simulation unit 1. In an embodiment, the simulation unit 1 is used for simulating the controller 20, which can be a customized controller consisting of, for example, a controller chip and relevant electronic components, and can be selectively integrated in the server 90 or provided separately from the server 90.

In an embodiment, as shown in FIG. 2A, the functional elements of the simulation unit 1 include a data collection portion 10, a calculation portion 11 and an analysis portion 12. The data collection portion 10 is used for collecting motion parameter information of the controller 20 in order to set simulation parameters for simulating a trajectory of the controller 20. The calculation portion 11 is used for calculating at least one simulation command based on the simulation parameters. The analysis portion 12 is used for inputting the simulation command into the target machine 2 for response comparison to determine whether the simulation command corresponds to a target command issued by the controller 20 for controlling the target machine 2.

Further, the steps for simulating of the controller 20 by the simulation unit 1 are as follows.

First, in step S21, the data collection portion 10 captures the motion parameter information of the controller 20 using communication transmission. A user arbitrary selects a trajectory (e.g., a processing route), such as a straight line, a turning line, or an arc; the present disclosure is not limited to as such, and the trajectory is inputted into the data collection portion 10. In step S22, the user sets parameters for a simulation trajectory based on the trajectory, such as a spatial parameter (a simulation parameter), wherein the space can be a two-dimensional space or a three-dimensional space. Next, in step S23, the user sets an acceleration/deceleration parameter (i.e., a simulation parameter) based on the spatial parameter, wherein the acceleration/deceleration parameter may include a pre-interpolation time constant (Tb), a post-interpolation time constant (Ta), a pre-interpolation axial acceleration (Ap), an axial maximum speed difference limit (Vc) or a combination of the above. The settings of the acceleration/deceleration parameters by the user can be represented in the form of graphs. FIG. 2B shows a graph depicting acceleration/deceleration parameters before interpolation set by the user, wherein the solid line R1 represents the speed curve, and the dotted line R2 represents the acceleration curve after calculation. T1 is the period in which acceleration increases; T2 is the period in which the acceleration increases and then holds steady; and T3 is the period acceleration increases, holds steady, and decreases. After interpolation, a graph showing curves for acceleration/deceleration parameters before and after interpolation can be provided as shown in FIG. 2C. The solid line R3 is a curve representing the acceleration/deceleration before interpolation; the dotted line R4 is a curve representing the acceleration/deceleration after interpolation; Tb is the duration in which acceleration increases before interpolation; T2 is the duration in which acceleration increases and holds steady before interpolation; Tc is the duration in which acceleration decreases before interpolation; and Ta is an acceleration/deceleration period after interpolation. Therefore, the total acceleration/deceleration interval before interpolation is the sum of T2 and Tc, and the total acceleration/deceleration interval after interpolation is the sum of T2, Tc and Ta. It should be noted that if the acceleration/deceleration parameter exceeds a limit, then the spatial parameter needs to be reset (e.g., in step S23′).

Next, in step S24, the calculation portion 11 calculates a speed command and an acceleration command based on the acceleration/deceleration parameters. In an embodiment, built-in mathematical integration methods can be used to calculate the speed command and the acceleration command Numerous integration methods can be used, and the present disclosure is not limited to a specific integration method. Then, in step S25, the calculation portion 11 calculates a position command (a simulation command) based on the speed command and the acceleration command Since the target machine 2 cannot work based on inputs of the speed and acceleration commands, a position command (a simulation command) is thus calculated based on the speed and acceleration commands As such, the target machine 2 is able to actuate based on the relative relationship of positions.

Then, in step S26, the simulation command (position command) is automatically input into the target machine 2, so that the analysis portion 12 can perform response comparison. In other words, the analysis portion 12 compares the position command with a historical data (e.g., a target command issued by the controller 20 for controlling the target machine 2) to obtain a simulation error in order to determine whether the simulation command corresponds to the target command. In an embodiment, if a value of the simulation error is less than a predetermined value, the simulation command corresponds to the target command of the controller 20, and the simulation process is ended (e.g., in step S27). Else if a value of the simulation error is greater than the predetermined value, the simulation command cannot correspond to the target command of the controller 20, so the calculation portion 11 needs to re-calculate the speed command and the acceleration command (e.g., in step S26′).

With the simulation method above, the simulation unit 1 is able to effectively simulate the trajectory formation of the controller 20 of the target machine 2 (machine tool) in order to predict the impact of parameter adjustments on the trajectory. And then the simulation unit 1 is able to analyze whether the adjustments meet the actual requirements, in other words, if two trajectories approximate each other. As shown in FIGS. 2D-1 to 2D-4, the position trajectory of the simulation unit 1 and the position trajectory of the controller 20 almost overlap each other, and so do their speed, acceleration and jerk trajectories, thereby demonstrating that the simulation method in FIG. 2A is effective in obtaining the control parameters of the controller 20.

It can be appreciated that, in steps S21-S23, if the conditions set by the user do not match those of the controller 20, the comparison of the responses cannot be performed in step S26.

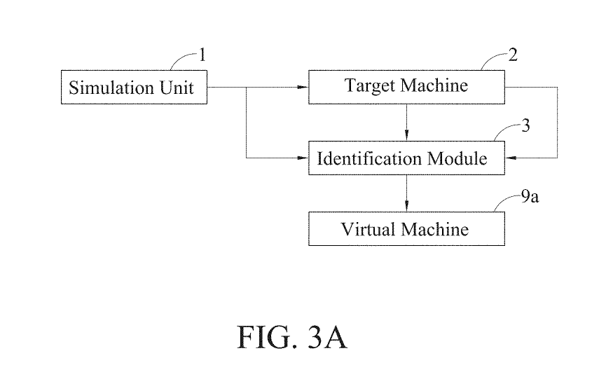

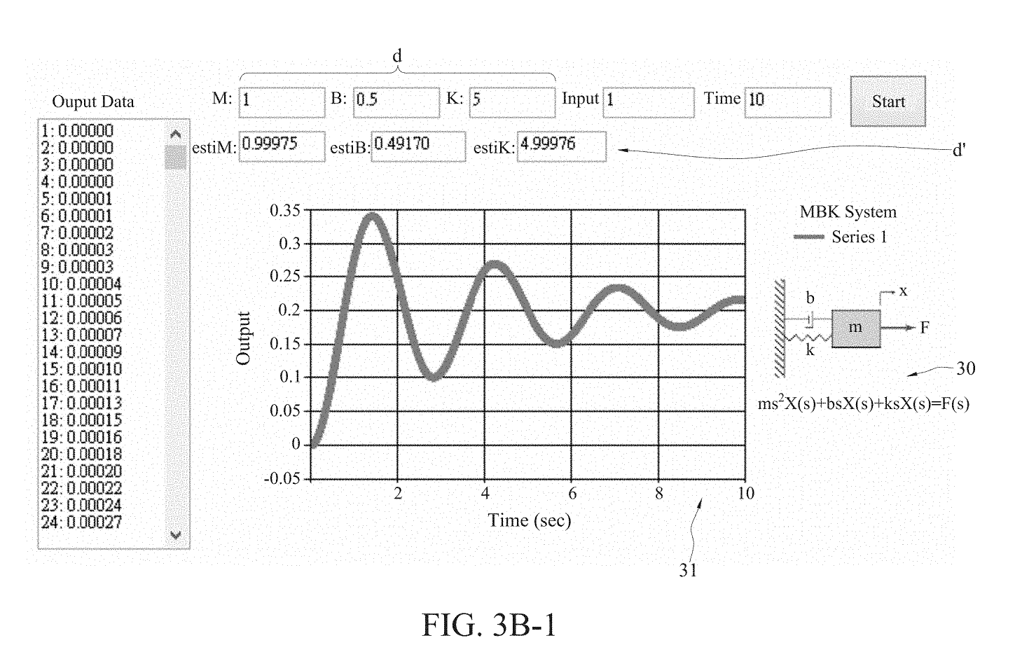

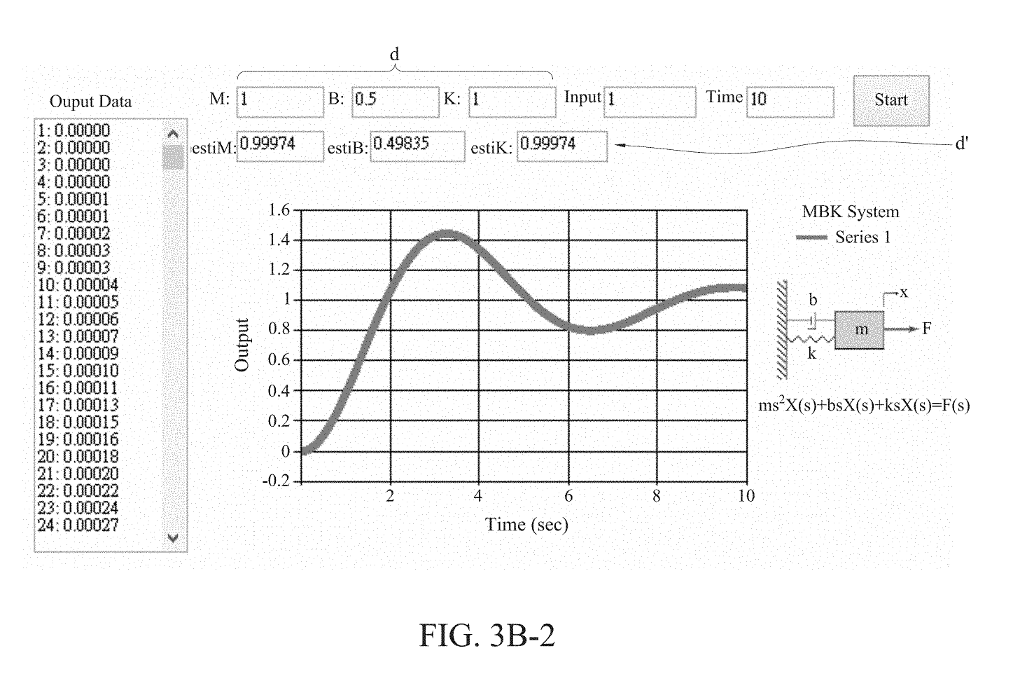

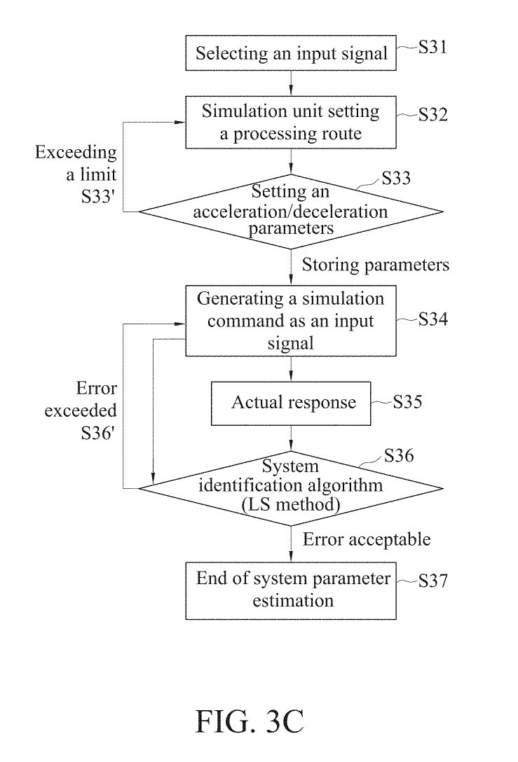

FIGS. 3A to 3C are diagrams illustrating a system identification method in accordance with the present disclosure.

When the tuning system 9 is modeling the target machine 2 for the first time, albeit a virtual machine 9a can be established by simulating the controller 20 using the simulation unit 1, the servo system of the target machine 2 needs to be identified in order for the virtual machine 9a to operate just like the target machine 2. The servo system includes position, speed, current control loop and dynamic electrical characteristics in order to understand the impacts of different motors and servo parameters on the servo system.

As shown in FIG. 3A, in an embodiment the server 90 of the tuning system 9 is equipped with an identification module 3 for identifying the servo system of the target machine 2. During system identification, the simulation unit 1 inputs a simulation command containing simulation parameters into the target machine 2 and the identification module 3, so that the target machine 2 generates response information. The response information is then transmitted to the identification module 3. The identification module 3 compares the simulation command and the response information. If the error values of the simulation parameters are within a reasonable range, the simulation parameters and the response information are used as system parameters of the target machine 2 (e.g., values of system parameters 3a shown in FIG. 4C). As such, the virtual machine 9a is established, wherein the system parameters are, for example, a combination of a mass coefficient (M), a damping coefficient (B) and a spring coefficient (K). In other words, once the combination of the mass coefficient (M), the damping coefficient (B), and the spring coefficient (K) is obtained, the virtual machine 9a can be formed for simulating the actual motion behaviors of the target machine 2.

An algorithm software of the identification module 3 performs comparison using the method of least square (LS) as shown below:

$$y ( t ) = {φ}_{1} ( t ) {θ}_{1} + {φ}_{2} ( t ) {θ}_{2} + Λ + {φ}_{n} ( t ) {θ}_{n} = {φ}^{T} ( t ) θ$$

$$φ ( t ) = {[ \begin{matrix}{φ}_{1} ( t ) \\ {φ}_{2} ( t ) \\ M \\ {φ}_{n} ( t )\end{matrix} ]}_{n \times 1} θ = {[ \begin{matrix}{θ}_{1} \\ {θ}_{2} \\ M \\ {θ}_{n}\end{matrix} ]}_{n \times 1} Φ = {[ \begin{matrix}{{φ}^{T} ( 1 )}_{1 \times n} \\ {{φ}^{T} ( 2 )}_{1 \times n} \\ M \\ {{φ}^{T} ( t )}_{1 \times n}\end{matrix} ]}_{t \times n}$$

$$Y ( t ) = {[ \begin{matrix}y ( 1 ) \\ y ( 2 ) \\ M \\ y ( t )\end{matrix} ]}_{t \times 1} = {Φ ( t )}_{t \times 1} {θ}_{n \times 1}$$

$$e ( i ) = y ( i ) - \hat{y} ( i ) = {φ}^{T} ( i ) θ - {φ}^{T} ( i ) \hat{θ}$$

$$E ( t ) = {[ \begin{matrix}e ( 1 ) \\ e ( 2 ) \\ M \\ e ( t )\end{matrix} ]}_{t \times 1} = {[ \begin{matrix}y ( 1 ) \\ y ( 2 ) \\ M \\ y ( t )\end{matrix} ]}_{t \times 1} - {[ \begin{matrix}\hat{y} ( 1 ) \\ \hat{y} ( 2 ) \\ M \\ \hat{y} ( t )\end{matrix} ]}_{t \times 1} = Y ( t ) - \hat{Y} ( t )$$

wherein i=positive integer of 1−t;

y(i) is an actual system output;

\dot{y}(i) is an estimated system output;

ϕ(t) is a system input matrix;

ϕ^{T}(i) is a transpose matrix of a system input matrix;

θ is a system coefficient matrix;

\hat{θ} is a system estimated coefficient matrix;

Φ is a transpose matrix of ϕ(t);

Y(t) is a system output matrix;

e(i) is an estimated error; and

E(t) is an estimated error matrix.

Next, an error value by matrix multiplication is estimated as follows:

V(θ, t)=½E^{T}(t)_{t×1}E(t)_{t×t}=½∥E(t)∥²=½∥Y(t)−\hat{Y}(t)∥²=½∥Φ(t)_{t×1}θ_{t×n}−Φ(t)_{t×1}\hat{θ}_{n×1}∥²

The term V(θ, t) is the output, the term on the right of the equal sign ½∥Φ(t)_{t×n}θ_{n×1}−Φ(t)_{t×1}∥² is the input, and E(t)^{T} is the transpose matrix of the estimated error matrix. Since θ is the system coefficient matrix, and \hat{θ} is the system estimated coefficient matrix, the mass coefficient (M), the damping coefficient (B) and the spring coefficient (K) can be obtained by calculating the value of θ.

In order to minimize the error value, another multiplication matrix can be used as shown below:

Φ(t)_{t×n}\hat{θ}_{n×1}=Φ(t)_{t×n}θ_{n×1}

This equation is multiplied by Φ^{T}(t) on both sides, such that the right term carries out an inverse matrix:

$${{Φ}^{T} ( T )}_{n \times t} {Φ ( t )}_{t \times n} {\hat{θ}}_{n \times 1} = {{Φ}^{T} ( t )}_{n \times t} {Φ ( t )}_{t \times n} {θ}_{n \times 1}$$

$$\begin{matrix}{\hat{θ}}_{n \times 1} = {[ {{Φ}^{T} ( t )}_{n \times t} {Φ ( t )}_{t \times n} ]}^{- 1} {{Φ}^{T} ( t )}_{n \times t} {Φ ( t )}_{t \times n} {θ}_{n \times 1} \\ = {[ {{Φ}^{T} ( t )}_{n \times t} {Φ ( t )}_{t \times n} ]}^{- 1} {{Φ}^{T} ( t )}_{n \times t} {Y ( t )}_{t \times 1}\end{matrix} \\ ⇒ \hat{θ} = {[ {Φ}^{T} Φ ]}^{- 1} {Φ}^{T} Y$$

The system estimated coefficient matrix \hat{θ} is the output, Φ and Φ^{T} are inputs, and Y is a constant. Since the above equation is a mathematical equation, conditions represented by the equation can be arbitrarily defined. In an embodiment, the inputs can be the simulation command containing the simulation parameters of the simulation unit 1, i.e., the inputs can be the mass coefficient (M), the damping coefficient (B), and the spring coefficient (K).

In an embodiment, verification interfaces of the identification module 3 as shown in FIGS. 3B-1 and 3B-2 each include system parameters (e.g., the mass coefficient (M), the damping coefficient (B), and the spring coefficient (K)), a model 30 of the system parameters and a dynamic simulation diagram 31 of the system parameters. In order to verify the accuracy of the identification module 3 so as to determine the validity of the algorithm, a target system parameter d can be inputted arbitrarily, for example, the value of the spring coefficient (K) is changed from 5 to 1 for verification. The LS algorithm described above is used for calculating the estimated system parameter d′ (value changed from 4.99976 to 0.99974), which approximately equals to the target system parameter d (i.e., 4.99976 approximates 5, and 0.99974 approximates 1). Therefore, the identification module 3, through the use of the LS algorithm, is able to effectively obtain the system parameters of the target machine 2.

Moreover, the calculated system parameters, such as the mass coefficient (M), the damping coefficient (B), and the spring coefficient (K), can be used to formulate a model 30 as shown below:

ms²X(s)+bsX(s)+ksX(s)=F(s), wherein s is a constant.

The model formula is built in the server 90, so that an appropriate formula can be selected based on the obtained system parameters. Therefore, the system parameter model 30 is provided to facilitate the understanding of the relationships of the mechanics and the physics between system parameters M, B, and K, which can be optionally displayed.

Moreover, the dynamic simulation diagram 31 of the system parameters shows the status of the calculated system parameters, such as the mass coefficient (M), the damping coefficient (B), and the spring coefficient (K), during system operations of the target machine 2. Therefore, the dynamic simulation diagram 31 of the system parameters is provided to facilitate the understanding of actual status of the system parameter model 30 during system operations of the target machine 2, as shown by different curves in FIGS. 3B-1 and 3B-2, and can be optionally displayed.

Therefore, the trajectory of the simulation unit 1 (customized controller) can be inputted to the identification module 3 of the tuning system 9 to simulate the system response of the target machine 2 (actual machine tool) when acceleration/deceleration. More specifically, as shown in FIG. 3C, first, in step S31, the user selects a type of input signal (e.g., speed, position or other options). Then in steps S32 and S33, a processing route and acceleration/deceleration parameters are set by the simulation unit 1 (similar to steps S21 to S23). It should be noted that if an acceleration/deceleration parameter exceeds a limit, then the processing route is reset (as in step S33′).

Next, in step S34, similar to steps S24 and S25, the simulation unit 1 converts the acceleration/deceleration parameters into a simulation command (e.g., a speed command, an acceleration command or a position command) Then in step S35, the output (i.e., the response information) of the target machine 2 is obtained based on the simulation command.

Thereafter, in step S36, the identification module 3 performs system identification of the target machine 2 based on the response information of the target machine 2 and the simulation command (as input) by using the LS algorithm described above to obtain an identification error value. Further, relevant system parameters of the target machine 2 are obtained, thereby completing the estimation of the servo system of the target machine 2 (as in step S37). It should be noted that if the identification error value is too large, the simulation unit 1 will reformulate a simulation command, as shown in step S36′.

It can be appreciated that, in steps S31-S33, if the conditions set by the user do not match with the conditions of the controller 20, then comparison of the response in step S35 cannot be performed.

As can be seen, in order to prevent the trajectory selected by the simulation unit 1 not conform with the system operations of the target machine 2, system identification of the target machine 2 is performed by the identification module 3 (for example, the simulation unit 1 requires an arc movement, but the system of target machine 2 can only perform straight line movement, so the identification module 3 performs corrections such that the virtual machine 9a can only perform straight line movements). Thus, when the user uses the tuning system 9 to establish the virtual machine 9a, the identification module 3 first needs to be employed in order to identify the system of the target machine 2 and to obtain the necessary system parameters.

FIGS. 4A to 4F are diagrams illustrating a tuning method in accordance with the present disclosure, wherein the tuning system 9 has completed the establishment of the virtual machine 9a.

As shown in FIG. 4A, in steps S41 and S42 a processing condition is set by the user in a built-in interface (not shown) of the tuning system 9, for example, the processing condition could be precision requirement, speed requirement, roughness requirement or a combination of the above (as shown in FIG. 4B). Next, in step S43, an error limit based on the processing condition is set by the user in a built-in interface (not shown) of the tuning system 9, for example, the error limit may be a route error limit, a processing time limit, an axial error limit or a combination of the above. Specifically, the precision requirement corresponds to the route error limit; the speed requirement corresponds to the processing time limit; and the roughness requirement corresponds to the axial error limit. Then, in step S44, tuning parameters are set by the user using an interface of the virtual machine 9a (e.g., FIG. 4C or 4D), for example, control parameters a are inputted. Then, in step S45, a tuning motion (processing) route (e.g., the trajectory la shown in FIG. 4C) is set by the user on the interface, then the virtual machine 9a is made to calculate parameters based on the above settings (e.g., by pressing an “execute (SIM)” button 41). Then, in step S46, the existing parameters of the controller 20 (e.g., the control parameters of a PID controller) are inputted (manually or by automatic transmission) into the virtual machine 9a for calculation and measurements. As such, the statuses of the control parameters for the trajectory la are obtained, which are represented in simulated motion routes S and S′ in dynamic simulation diagrams 40. The motion routes S and S′ are compared with the actual motion routes L and L′ of the target machine 2 to obtain error values t and t′. Finally, if the error value t′ is less than the predetermined value (according to the setting of S43), then in step S47, these control parameters are adopted by the user and their values are stored. Else if the error value t′ is greater than the predetermined value, in step S46′ the tuning parameters are reset by the user.

In an embodiment, the interfaces of the virtual machine 9a are configured based on the information obtained by the simulation unit 1 and the identification module 3. For example, the interface of FIG. 4C or 4D shows a time response, and the interface of FIG. 4E shows a frequency response of the virtual machine 9a. In addition to the type of controller 1b, the trajectory la, the model formula 1c of the controller 20, the simulation time 1d, the “execute” button 41, the system parameters 3a defined by the identification module 3, the system type 3b, the system parameter model 3c, the control parameter a, the control parameter b, and the dynamic simulation diagram 40 are shown in the interface of FIG. 4C or 4D.

The control parameters depend on the type of controller 20, for example, the parameters of a PID (Proportional-Integral-Derivative) controller may be proportional gain (Kₚ), integration time (Tᵢ), derivative time (T_{d}), natural frequency (N) or other values a, b. It can be appreciated that the control parameters may also be parameters of a PI controller. Therefore, the parameters obtained by the simulation unit 1 in accordance with steps S21-S27 are displayed on the interface of FIG. 4C, 4D or 4E.

The trajectory 1a is a tuning route selected during adjustments of the parameters, which includes the options of several processing routes for user's selection and settings. Therefore, after the user has inputted the control parameters a, b and selected the trajectory 1a, the user may then press the “execute” button 41 (the system parameters 3a have been determined during system identification described with respect to FIGS. 3A to 3C).

The type of controller 1b is obtained from simulation of the simulation unit 1. Thus, a single tuning system 9 may store many different types of controller 1b. For example, the controller 20 may be a PID controller or a PI controller, which can be selected and set by the user.

The model formula 1c is a built-in mathematical formula based on the model shown below:

G_{PID}(S)=Kₚ[(1/TᵢS)+1+T_{d}S/(1+T_{d}S/N)], and S is a constant.

An appropriate model formula 1c can be selected based on the control parameters of the controller 20 obtained by the simulation unit 1. Thus, the model formula 1c is provided to facilitate the understanding of mechanics and physics between system parameters M, B, and K, which can be optionally displayed. Once the user has chosen the type of controller 1b, the interface of FIG. 4C, 4D or 4E will display the appropriate model formula 1c accordingly.

The simulation time 1d is the time it takes for the virtual machine 9a to perform parameters calculation in units of seconds. Therefore, after the user presses the “execute” button 41 and the virtual machine 9a has completed its calculation, the simulation time 1d (in seconds) will be displayed on the interface of FIG. 4C, 4D or 4E.

The dynamic simulation diagram 40 shows various simulation comparisons according to needs. More specifically, in one interface such as that shown in FIG. 4C or 4D, the input of the values of control parameters a and b into the target machine 2 results in the actual motion routes L and L′. On the other hand, the virtual machine 9a calculates the simulated motion routes S and S′ based on the values of control parameters a and b. The actual motion route L, the actual motion route L′, the simulated motion route S, and the simulated motion route S′ are displayed in the dynamic simulation diagram 40 so as to allow the user to graphically compare and see the error values t and t′. Alternatively, in another interface such as that shown in FIG. 4E, the dynamic simulation diagram 40 shows a magnitude graph E1 and a phase graph E2.

As aforementioned, values of the system parameter 3a are determined during system identification described with respect to FIGS. 3A to 3C.

The system type 3b is the servo system of the target machine 2 identified by the identification module 3. Thus, a single tuning system 9 may store a plurality of system types 3b according to the types of machines available in the intended factory for user selection.

The system parameter model 3c is determined during system identification as shown in FIGS. 3A to 3C, in other words, a specific model is selected based on the system parameters. Thus, it can be ms²X(s)+bsX(s)+ksX(s)=F(s) shown in FIG. 3B-1, or the formulae shown in FIGS. 4C and 4D:

M₁ [symbol] +B( [symbol] - [symbol] )+K(X₁-X₂)=F

M₂ [symbol] −B( [symbol] - [symbol] )−K(X₁-X₂)=0

Thus, the present disclosure is not limited to a particular form of system parameter model 3c. After the user selects the system type 3b, the system parameters 3a and the system parameter model 3c are automatically displayed on the interface shown in FIG. 4C, 4D or 4E.

However, there are numerous ways for presenting any interface of the virtual machine 9a. The present disclosure is not limited to those shown above, and can be modified according to needs.

Furthermore, in step S45, during calculation of the control parameters, the virtual machine 9a adjusts the control parameters (e.g., any one or more of proportional gain Kₚ, integration time Tᵢ, derivative time T_{d}, natural frequency N) in a loop method to obtain control parameters with the minimum error value. For example, a built-in software in the virtual machine 9a for calculating the control parameters in real time may use the classical fourth-order Runge-Kutta method as shown below.

Given that the system initial value y′(x)=f(x,y) and y(x₀)=y₀, then y can be approximated as y(i₊₁₎=yᵢ+(k₁+2k₂+2k₃+k₄)/6. The equations are further shown below.

kᵢ=□f(xᵢ, yᵢ);

k₂=□f(xᵢ+□/2, yᵢ+k₁/2);

k₃=□f(xᵢ+□/2, yᵢ+k₁/2);

k₄=□f(xᵢ+□, yᵢ+k₃);

xᵢ=x₀+□;

The term y₍ᵢ₊₁₎ is the output; the term on the right of the equal sign yᵢ+(k₁+2k₂+2k₃+k₄)/6 (yᵢ and k₁ [symbol] k₂ [symbol] k₃ [symbol] k₄) are inputs; and h is a constant. Since the above formula is a mathematical formula, the conditions it represents can be arbitrarily defined. For example, the input values can be the present parameters of the controller 20 (e.g., proportional gain Kₚ, integration time Tᵢ derivative time T_{d}, natural frequency N shown in FIG. 4C), and the output values can be the control parameters after adjustment (e.g., values of proportional gain Kₚ, integration time Tᵢ derivative time T_{d}, natural frequency N of the control parameter b shown in FIG. 4D). More specifically, during calculation, the obtained values of the control parameters a and b will result in different simulated motion routes S and S′ and actual motion routes L and L′ being displayed in the dynamic simulation diagram 40, which allows the user to easily determine the change in the error values t and t′.

Further, the validity of the method shown in FIG. 4A can be verified by comparison. More specifically, when the processing condition concerns roughness requirement, as shown in FIG. 4F-1, curves U1-U4 obtained during calculations of the virtual machine 9a are integrated into one graph. In the same speed interval, as the acceleration limit becomes larger, the axial dynamic error becomes smaller as indicated by an arrow Z. The arrow Z shows that the axial dynamic errors are becoming smaller from curve U1 towards curve U4. In FIG. 4F-1, the speed is measured in units of mm/s, and the axial dynamic error is measured in units of 0001 mm.

When the processing condition concerns speed requirement, as shown in FIG. 4F-2, curves P1-P4 represent first to fourth acceleration curves, and curves V1-V4 represent first to fourth speed curves. The first acceleration curve P1 corresponds to the first speed curve V1; the second acceleration curve P2 corresponds to the second speed curve V2; the third acceleration curve P3 corresponds to the third speed curve V3; and the fourth acceleration curve P4 corresponds to the fourth speed curve V4. When reaching the same speed requirement (the first to fourth speed curves V1-V4 have the same maximum values), as the acceleration (as indicated by arrow Y′) becomes larger, the acceleration time (as indicated by arrow X) becomes shorter.

When the processing condition concerns precision requirement, as shown in FIG. 4F-3, it can be seen that as the corner error becomes smaller, the geometric error becomes smaller.

Thus, when the tuning system 9 performs parameter adjustments, the simulation unit 1 and the identification module 3 performs in advance the simulation and the system identification operations, respectively. That is, a virtual machine 9a is established, and information is displayed on at least one interface (e.g., the interfaces shown in FIGS. 4D and 4E). The interfaces allow the user to set a processing condition for the target machine 2 to be simulated and input the present control parameters (i.e., simulation command containing simulation parameters) of the controller 20 to be adjusted into the virtual machine 9a as described with respect to steps S41-S45.

Next, in steps S45 and S46, the user presses the “execute” button 41 to make the virtual machine 9a calculate the required control parameters (or optimized parameters) in real time using its built-in software (e.g., a software constructed based on the classical 4th order Runge-Kutta method as described above). The actual response (e.g., the actual motion routes L and L′) of the target machine 2 and the simulated response (e.g., the simulated motion routes S and S′) generated by the virtual machine 9a in simulating the target machine 2 are displayed in the dynamic simulation diagram 40. That is, the simulation of the response of the target machine 2 is performed by the virtual machine 9a based on the simulation parameters. In actual operations, the virtual machine 9a calculates and adjusts the control parameters a of FIG. 4C (e.g., parameters before calculation or during calculation, or the present parameters of the controller 20) to the control parameters b of FIG. 4D (with a smaller error value t′).

Thereafter, in step S47, the control parameters b after calculation by the virtual machine 9a are used as the initial base parameters (e.g., the control parameters of the controller 20) for tuning the target machine 2. Finally, the parameters on the target machine 2 are quickly adjusted manually or through automatic transmission of the tuning system 9, thereby significantly saving time taken for adjusting the parameters of the target machine 2.

In addition, the trajectory la provided by the simulation unit 1 can be inputted into the virtual machine 9a. The virtual machine 9a simulates the response generated by the mechanical structure with respect to acceleration/deceleration. The virtual machine 9a may also be used to simulate the compensation of the servo system on friction and backlash caused by the machine or the suppression of structure vibration.

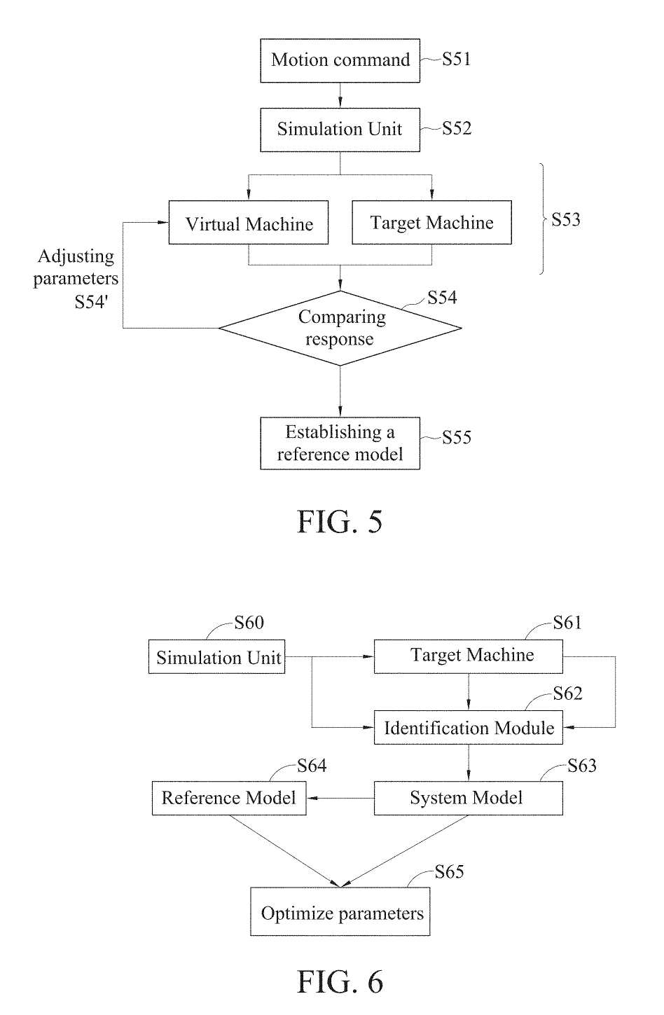

FIGS. 5 and 6 are diagrams illustrating a tuning method in accordance with another embodiment of the present disclosure.

In this embodiment, the tuning system 9 may use the identification module 3 to store control parameters obtained after each parameter adjustment by the virtual machine 9a or obtained from measuring the target machine 2 (same or different machine tool) in normal circumstances each time. The control parameters are used as comparison parameters for establishing a reference model.

As shown in FIG. 5, the formation of a reference model is first carried out in steps S51 to S53, in which a motion command (simulation command) is inputted via the simulation unit 1 into the virtual machine 9a and the target machine 2. As such, the target machine 2 generates a first response information, and the virtual machine 9a generates a second response information. Then, in step S54, the first and second response information are compared. When the error values between the virtual machine 9a and the target machine 2 are less than a predetermined value (i.e., the error values are within a permitted range), then the second response information is stored for establishing the reference model as shown in step S55. Else if the error values between the virtual machine 9a and the target machine 2 are greater than the predetermined value, the simulation parameters of the simulation command are revised.

Therefore, the present disclosure is able to obtain the reference model of the target machine 2 via the identification module 3 at first. During adjustment of the parameters, as shown in FIG. 1B and FIG. 6, the user sets a processing condition. Then in steps S60 to S63, the control parameters (motion command) of the controller 20 captured by the simulation unit 1 are inputted into the target machine 2 and the identification module 3. As such, a system model (e.g., a first virtual machine) is obtained by the tuning system 9 simulating the response of the target machine 2. Further, a reference model suitable for the processing condition (e.g., a second virtual machine) is provided by the tuning system 9 in step S64. By using a mathematical algorithm software (e.g., based on classical 4th order Runge-Kutta method above), differences between the reference model and the system model are calculated in real time. Later, the optimized parameters are calculated as shown in step S65. In the dynamic simulation diagram 40, the actual motion routes L are L′ are replaced by the motion routes of the reference model so as to obtain the error values between the motion routes of the system model and the reference model. These parameters (e.g., the numerical values in the control parameter columns in FIG. 4D) can be used as the initial parameters for automatic tuning process, thereby saving the time for users to adjust the parameters of the target machine 2.

In conclusion, the tuning system 9 and the tuning method of the present disclosure constructs the virtual machine 9a that effectively simulates the target machine 2 through the use of the simulation unit 1 and the identification module 3. Thus, regardless of the experience of the operator, the operator only needs to set relevant conditions on the interfaces of the tuning system 9. The virtual machine 9a can then quickly calculate and carry out the parameters required for the controller 20 (e.g., in steps S45 and S46). The operator can directly adopt these calculated parameters (e.g., the values of the control parameters b) or fine tune the parameters, thereby allowing the operator to easily adjust the parameters of the controller 20 of the target machine 2 without trials and errors using a lot of parameter values.

Furthermore, the tuning system 9 of the present disclosure enables remote tuning (still needs the present parameters of the controller 20 to input into the columns of the values of the control parameters a in the interface shown in FIG. 4C). The tuning system 9 can simultaneously perform adjustments of parameters for a plurality of target machines 2 (machine tools).

Moreover, the system identification method of the identification module 3 uses the simulation command of the simulation unit 1 as its input signal.

In addition, the simulation unit 1 can be used alone for simulating the controller 20 without being limited to only work in cooperation with the tuning system 9.

The above embodiments are only used to illustrate the principles of the present disclosure, and should not be construed as to limit the present disclosure in any way. The above embodiments can be modified by those with ordinary skill in the art without departing from the scope of the present disclosure as defined in the following appended claims.

What is claimed is:

1. A tuning method, comprising:
providing a tuning system equipped with a virtual machine, wherein the virtual machine is modeled after a target machine;
setting a processing condition of the target machine in the tuning system;
inputting a simulation command containing a simulation parameter into the virtual machine; and
subjecting the virtual machine to simulate a response of the target machine according to the simulation parameter to calculate required control parameters and use the control parameter as a base parameter for adjusting the target machine.

2. The tuning method of claim 1, wherein the tuning system is further provided with an identification module, and the tuning method, prior to setting the processing condition, further comprising:
inputting another simulation command containing another simulation parameter into the virtual machine for the target machine to generate response information;
transmitting the response information to the identification module; and
subjecting the identification module to compare the another simulation command and the response information, and using the another simulation parameter and the response information as a system parameter if an error value of the another simulation parameter is within an acceptable range.

3. The tuning method of claim 2, wherein the tuning system is further provided with a simulation unit configured for transmitting the another simulation command to the target machine and the identification module.

4. The tuning method of claim 3, wherein the target machine includes a controller, and the simulation unit is configured for simulating the controller.

5. The tuning method of claim 1, wherein the tuning system is further provided with a reference model established by using the virtual machine, and the reference model includes comparison parameters.

6. The tuning method of claim 5, further comprising:
selecting the reference model based on the processing condition of the target machine, and comparing with the control parameter so as to calculate another control parameter.

7. A tuning system, comprising:
a server equipped with a virtual machine, wherein the virtual machine is modeled after a target machine;
an identification module configured for identifying the target machine so as to establish the virtual machine; and
a simulation unit configured for simulating a controller of the target machine for the identification module to identify the target machine.

8. The tuning system of claim 7, wherein the simulation unit is configured for transmitting a simulation command to the target machine and the identification module for the identification module to identify the target machine.

9. A simulation method for simulating a controller by a simulation unit, the controller being configured for controlling motions of a target machine, the simulation method comprising:
setting a parameter for a simulation trajectory;
calculating a simulation command based on the parameter; and
inputting the simulation command into the target machine for response comparison so as to determine whether the simulation command corresponds to a target command of the controller for controlling the target machine.

10. The simulation method of claim 9, wherein the simulation unit is another controller.

11. The simulation method of claim 9, wherein the simulation unit sets the parameter for the simulation trajectory by collecting motion parameter information of the controller.

12. The simulation method of claim 9, wherein the simulation unit determines whether the simulation command corresponds to the target command based on a correlation between the simulation trajectory and motions of the target machine.

13. A simulation unit, comprising:
a data collection portion configured for setting a parameter for a simulation trajectory;
a calculation portion configured for calculating a simulation command based on the parameter; and
an analysis portion configured for inputting the simulation command into a target machine for response comparison to determine whether the simulation command corresponds to a target command of the controller for controlling the target machine.

14. The simulation unit of claim 13, wherein the simulation unit is another controller.

15. The simulation unit of claim 13, wherein the data collection portion sets the parameter for the simulation trajectory by collecting motion parameter information of the controller.

16. The simulation unit of claim 13, wherein the analysis portion determines whether the simulation command corresponds to the target command based on a correlation between the simulation trajectory and motions of the target machine.
